(19) United States
(12) Patent Application Publication
(10) Pub. No.: US 2006/0051070 A1
(43) Pub. Date: Mar. 9, 2006

(54) Image pickup apparatus and image playback method

(75) Inventor: Masakatsu Itsukaichi, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/220,698

(22) Filed: Sep. 8, 2005

(30) Foreign Application Priority Data
Sep. 9, 2004 (JP) 2004-262685
Jul. 1, 2005 (JP) 2005-193913

(51) Int. Cl. H04N 5/76; H04N 5/225

(52) U.S. Cl. 386/117; 348/207.99

(57) ABSTRACT

With the image pickup apparatus according to the present invention, a still image is recorded when the operation switch is pressed to the first depressed position and recording of moving images is started or stopped when the operation switch is pressed to the second depressed position. That is, by simply changing the depressed position of the single operation switch, the user can record a still image or start/stop recording moving images, eliminating the need to change shooting mode each time. On the other hand, the image playback method according to the present invention displays still images together with moving images by identifying the still images based on the marking information corresponding to the moving-image frames being played back. This makes it possible to simultaneously view the moving images and the still images shot concurrently.

### BACKGROUND OF THE INVENTION

1. Field of the Invention

The present invention relates to an image pickup apparatus and image playback method. More particularly, it relates to an image pickup apparatus capable of shooting still images during shooting of moving images and a method for playing back still images recorded during shooting of moving images, together with the moving images.

2. Related Art

Conventionally, image pickup apparatus have been proposed which are capable of shooting still images during shooting of moving images. For example a technique disclosed in Japanese Patent Application Laid-Open No. 2000-324434 stores still photographic images picked up by a CCD, in response to a still-image recording request made during recording of moving images, prohibits images from being captured from the CCD into a frame memory for a predetermined time, and reads out images from the frame memory repeatedly in this period thereby recording the still photographic images as moving images in a memory card. Also the technique records images from the frame memory onto the memory card as still images during the moving-image processing. When the still-image recording time is ended, the prohibition is lifted and normal moving-image recording is restarted. A flash gun is charged except when signal charge is read out of the CCD.

### SUMMARY OF THE INVENTION

Normally, a release switch of a camera has a two-step configuration. When it is “half-pressed” (S1), i.e., when it is pressed lightly and held, automatic focusing (AF) and automatic exposure control (AE) comes into play. When the release switch is “fully pressed” (S2), i.e., when it is pressed further after being “half-pressed,” it functions as a record button. According to the technique disclosed in Japanese Patent Application Laid-Open No. 2000-324434, still images are shot during shooting of moving images. With this technique, after giving a command, in some way, to start shooting/recording moving images, the user must press the release switch of the camera, release switch on a remote control, or the like to give a command to record still images. The present invention has been made in view of the above circumstances and has an object to provide an image pickup apparatus which allows the user to give commands needed for both moving-image shooting and still-image shooting using a single operation switch without switching between shooting modes.

To achieve the above object, the present invention provides an image pickup apparatus comprising: an image pickup unit which outputs image data based on light coming from a subject via a taking lens; a moving-image recording unit which records moving images on a recording medium based on the image data outputted from the image pickup unit; a still-image recording unit which records still images on a recording medium based on the image data outputted from the image pickup unit; an operation switch which accepts a push operation to a first or second depressed position; and a recording controller which controls the still-image recording unit so as to record the still images on the recording medium when the operation switch is pressed to the first depressed position, and controls the moving-image recording unit so as to start or stop recording the moving images when the operation switch is pressed to the second depressed position.

According to this image pickup apparatus, a still image is recorded when the operation switch is pressed to the first depressed position; and recording of moving images is started or stopped when the operation switch is pressed to the second depressed position. That is, this invention allows the user to enter commands to record still images and moving images simply by pressing a single operation switch without switching between shooting modes. Incidentally, commands to carry out preparatory operations including autofocusing (AF) and automatic exposure control (AE) may be entered via an input device other than the operation switch, such as a touch panel.

The operation switch may accept a push operation to any of a first to third depressed position; and the recording controller may control the still-image recording unit so as to record the still images on the recording medium when the operation switch is pressed to the first or second depressed position, and controls the moving-image recording unit so as to start or stop recording the moving images when the operation switch is pressed to the third depressed position.

The image pickup apparatus has the operation switch which accepts a push operation to any of the first to third depressed position. It can record still images when the operation switch is pressed to the first or second depressed position and start or stop recording moving images when the operation switch is pressed to the third depressed position.

The recording controller may control the image pickup unit so as to prepare to carry out imaging of the subject when the operation switch is pressed to the first depressed position, and control the still-image recording unit so as to record the still images on the recording medium when the operation switch is pressed to the second depressed position.

The preparatory operations include automatic focusing (AF) and automatic exposure control (AE).

If the operation switch is pressed to the second depressed position during recording of the moving images, the recording controller may control the still-image recording unit so as to record the still images based on the same image data as the image data in moving-image frames recorded just when the operation switch is pressed to the second depressed position.

The moving-image recording unit may record marking information which identifies the still images by associating the marking information with moving-image frames recorded just when the operation switch is pressed to the second depressed position. Besides, the marking information may include audio data.

With an image playback method according to the present invention, still images taken during moving-image shooting can be played back simultaneously with the moving images using the marking information. The image playback method comprises the steps of: recording moving images; recording still images during recording of moving images; recording marking information which identifies the still images by associating the marking information with moving-image frames recorded just when the still images are recorded; playing back the recorded moving images on a display unit; identifying the still images based on the marking information corresponding to moving-image frames being played back; and displaying the identified still images on the display unit together with the moving images being played back.

The image playback method according to the present invention displays the still images together with the moving images by identifying the still images based on the marking information corresponding to the moving-image frames being played back. This makes it possible to simultaneously view the moving images and the still images shot concurrently.

The marking information may include audio data; and the image playback method may further comprise the step of playing back sound based on the audio data of the marking information corresponding to moving-image frames being played back.

Consequently, the shooting time of moving images and still images shot concurrently can be indicated by sound during playback of the moving images.

Programs which make a computer execute these image playback methods are also included in the present invention.

With the image pickup apparatus according to the present invention, a still image is recorded when the operation switch is pressed to the first depressed position and recording of moving images is started or stopped when the operation switch is pressed to the second depressed position. That is, by simply changing the depressed position of the single operation switch, the user can record a still image or start/stop recording moving images, eliminating the need to change shooting mode each time.

The image playback method according to the present invention displays still images together with moving images by identifying the still images based on the marking information corresponding to the moving-image frames being played back. This makes it possible to simultaneously view the moving images and the still images shot concurrently.

### BRIEF DESCRIPTION OF THE DRAWINGS

FIG. 1 is an external view of a digital camera according to a preferred embodiment of the present invention;

FIG. 2 is a rear perspective view of the digital camera;

FIG. 3 is a front perspective view of the digital camera;

FIG. 4 is a block diagram showing a digital camera according to a first embodiment;

FIG. 5 is a block diagram showing a shutter button with three depressed positions;

FIG. 6 is a flowchart showing a flow of a still-image shooting process;

FIG. 7 is a flowchart showing a flow of a moving-image shooting process;

FIG. 8 is a flowchart showing a flow of a concurrent moving/still-image shooting process;

FIG. 9 is a flowchart showing a flow of an image display process;

FIG. 10 is a block diagram showing an example of concurrent display of moving and still images;

FIG. 11 is a block diagram showing a digital camera according to a second embodiment;

FIG. 12 is a block diagram showing a shutter button with two depressed positions; and

FIG. 13 is a flowchart showing a flow of a concurrent moving/still-image shooting process according to the second embodiment.

### DETAILED DESCRIPTION OF THE PREFERRED EMBODIMENTS

Preferred embodiments of the present invention will be described below with reference to the drawings.

### First Embodiment

[General Configuration]

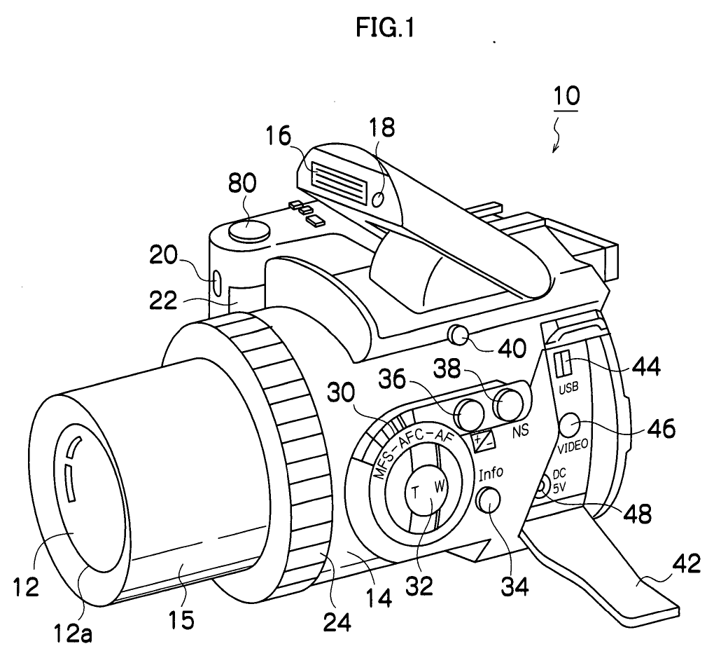

FIGS. 1 to 3 are external perspective views of a camera 10 according to a preferred embodiment of the present invention. The camera 10 is a digital camera equipped with a zoom lens 12. It has a size and shape which allow a photographer to prevent camera shake by holding a lens portion 14 and a body-side grip 22 securely, where the lens portion 14 protrudes forward from the camera body. A circular recess 12a is formed almost at the center in the front face of the zoom lens 12. A lens barrier (not shown) is provided in the recess 12a to cover the external surface of the lens 12 thereby protecting the lens 12 when the camera is not in use. The lens barrier can be opened and closed: opening it exposes the external surface of the lens 12 and closing it covers the external surface of the lens 12. The lens barrier is opened and closed by a lens barrier motor 166.

A pop-up flash unit 16 is provided on the top face of the camera and a flash sensor 18 is provided by the side of a flash light. Reference numeral 40 designates a flash open button used to pop up the flash unit 16 to its operating position. A shutter button 80 is installed on the top face of the grip 22 and a self timer lamp 20 is provided on the front face of the grip 22.

A focus zoom ring (hereinafter referred to as the FZ ring) 24 is provided in the lens portion 14. In Manual Focus (MF) mode, the photographer can adjust focus manually by turning the FZ ring 24 by hand. In Continuous Autofocus (C-AF) mode or Single Autofocus (S-AF) mode, the photographer can make optical zoom adjustment by turning the FZ ring 24 by hand. A mode selector switch 30 is used to switch among the MF, C-AF, and S-AF modes.

The mode selector switch 30 for use to switch among the MF, C-AF, and S-AF modes, a zoom key 32, an information button 34, an exposure correction button 36, and a white balance adjustment button 38 are provided on a flank of the camera 10. These controls are provided in such positions that the photographer can operate them with the thumb of his/her left hand which is holding the lens portion 14 of the camera.

The zoom key 32 is used both to adjust the focal length of the zoom lens 12 and specify digital zoom-in/zoom-out. It has a seesaw structure and tilts in the forward/backward direction of the camera 10, making it possible to change the focal length of the zoom lens 12 to the Tele side or Wide side depending on the direction of its tilt. Pressing the front side (T key) of the zoom key 32 adjusts the focal length to the telephoto (zoom-in) side and pressing the rear side (W key) of the zoom key 32 adjusts the focal length to wide-angle (zoom-out) side. Incidentally, the T key and W key may be installed separately so that they will move separately.

With the mode selector switch 30 set to C-AF or S-AF mode, the photographer can make optical zoom adjustment manually by turning the FZ ring 24 by hand. As an example, the zoom lens 12 moves to the telephoto side (zooms in) when the FZ ring 24 is turned clockwise as viewed from the back of the camera 10, and it moves to the wide-angle side (zooms out) when the FZ ring 24 is turned counter-clockwise. The relationship between the turning direction and telephoto/wide-angle direction may be reversed.

The information button 34 is used to display shooting conditions on a liquid crystal monitor 68 of the camera 10 with a single touch. The exposure correction button 36 is used to specify an amount of exposure correction for a camera image and the white balance adjustment button 38 is used to change a white balance setting.

When a terminal cover 42 on a flank of the camera 10 is opened, there are a communications connector (e.g., a USB terminal) 44 for use to send and receive information to/from other electronic equipment, video output terminal 46 for use to send and receive video signals, and power input terminal 48 for use to receive external power.

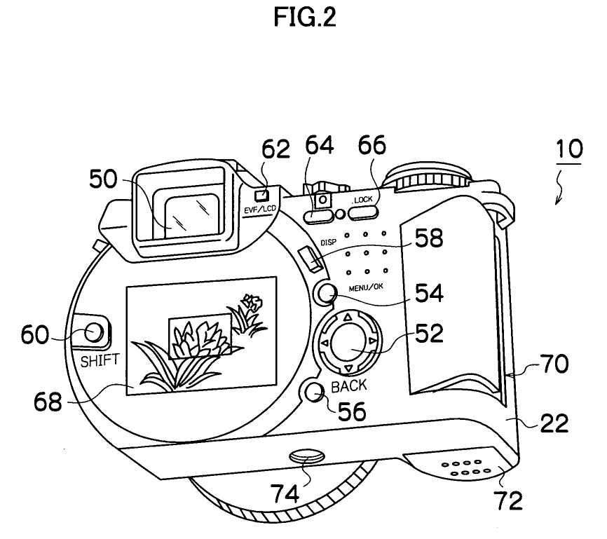

FIG. 2 is a rear perspective view of the camera 10. A finder 50 and the liquid crystal monitor 68 are provided on the camera back. Controls provided there include a cross-key pad 52, menu/enter button 54, cancel/return button 56, display button 58, shift button 60, display switch button 62, zoom-in button 64, and AE lock button 66 used to lock exposure time.

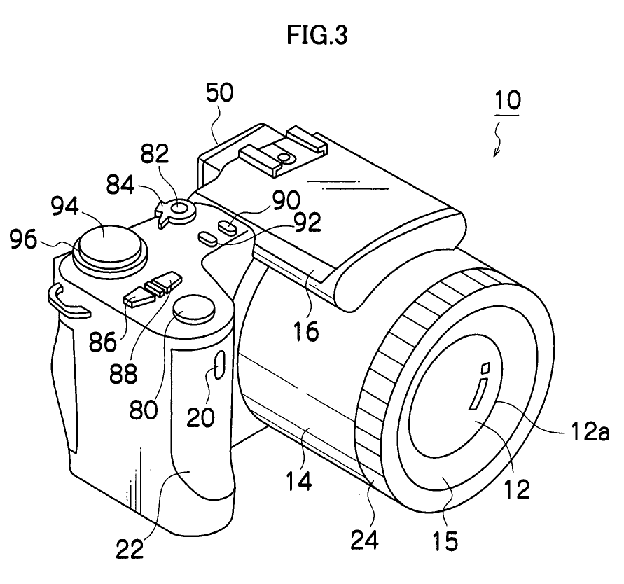

The finder 50 is an electronic viewfinder, but it may be substituted by an optical finder. The liquid crystal monitor 68 is used as an electronic finder to check the angle of view during shooting and as a display device to preview a taken image or display a reproduced image read out of an external recording medium such as a memory card. The display screen of the liquid crystal monitor 68 is also used when selecting a menu or making settings for individual items on each menu with the cross-key pad 52 or a command dial 96 (see FIG. 3). Furthermore, the liquid crystal monitor 68 can display such information as the number of remaining shots (frames), current frame number, Macro mode, recording image quality, and pixel count.

The photographer can adjust the angle of view by looking at the video image shown in the finder 50 or liquid crystal monitor 68. The display switch button 62 is a control used to switch the display location of images or information between the finder 50 and liquid crystal monitor 68.

The cross-key pad 52 has a multi-function key configured to give any of four direction commands (Up, Down, Left, and Right) when corresponding one of its edges (upper, lower, left, and right) is pressed. It is used to select menu items on a menu screen and change settings as well as to adjust the focal length (Tele/Wide) of the zoom lens 12, adjust the magnification of the digital zoom, move the center of zoom, and advance/reverse frames during playback. Incidentally, the cross-key pad 52 may consist of one member which tilts up, down, left, and right or consist of four separate keys (Up, Down, Left, and Right).

The menu/enter button 54 is used to move from a normal display screen to a menu screen in each mode, apply a selection, execute a process, etc. The cancel/return button 56 is used to cancel or undo a process. It allows the photographer to cancel a menu selection or restore the previous setting.

The display button 58 is used to turn on/off the liquid crystal monitor 68 or show/hide the frame number during playback. The shift button 60 is a push switch used to extend the functionality of a multi-function key such as the cross-key pad 52. The zoom-in button 64 is used to zoom in on part of a screen (e.g., the center of the screen) when checking whether the subject is in focus.

Of the controls provided on the camera back, the shift button 60 is provided in such a position that the photographer can operate it with his/her left hand, to allow the photographer to operate it simultaneously with other operation buttons (keys). The controls (52, 54, 56, 58, 62, 64, 66) other than the shift button 60 are provided in such positions that the photographer can operate them with the thumb of his/her right hand which is holding the grip 22 of the camera.

An openable slot cover 70 is provided on that flank of the camera where the grip 22 is located. A media slot (not shown) is provided inside the cover to mount an external recording medium. Also, there are a battery cover 72 for a battery compartment (not shown) and a screw hole 74 for a tripod on/in the bottom of the camera 10.

FIG. 3 is a perspective view showing the camera 10 with the flash unit 16 and a lens barrel 15 retracted. On the top face of the camera 10, there are the shutter button 80, a power switch 82, a mode lever 84, a flash button 86 for use to enable or disable firing of the flash unit 16, a macro button 88 for use to enable or disable Macro (Close-up) mode, a self-timer button 90, continuous shooting button 92 for use to enable or disable Continuous Shooting mode, a mode dial 94, and a command dial 96 for use to set various modes.

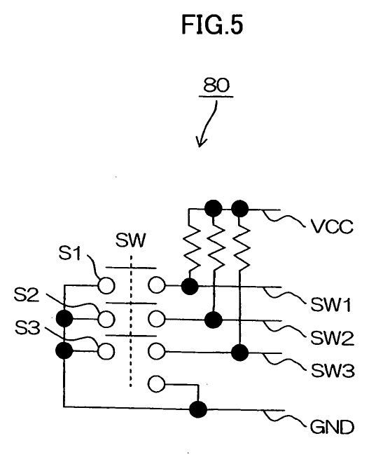

The shutter button 80 is used to give a command to start recording images. As shown in FIG. 5, the shutter button 80 can be depressed in three steps into a first depressed position S1, second depressed position S2, and third depressed position S3. When the shutter button 80 is pressed lightly to the first depressed position S1 (half pressed) and its stroke is stopped there, a switch SW1 is activated. When the shutter button 80 is pressed from the first depressed position S1 to the second depressed position S2 (fully pressed) and its stroke is stopped there, a switch SW2 is activated. When the shutter button 80 is pressed from the second depressed position S2 to the third depressed position S3 and its stroke is stopped there, a switch SW3 is activated.

The mode lever 84 is used to set the camera 10 to various modes of shooting and playback. It is a lever switch turnably supported around the power switch 82. Mode can be switched depending on the stop position of the mode lever 84.

The mode dial 94 is used to switch among various shooting modes. By turning the mode dial 94 and thereby aligning an appropriate symbol on the dial with an index mark, it is possible to select Setup mode, Manual Shooting mode, Aperture-Priority Shooting mode, Shutter-Priority Shooting Mode (normal shooting mode), Scene Selection mode for selection among night scene, portrait, and distant landscape, Moving-Image Recording mode, or Concurrent Moving/Still-Image Recording mode.

Setup mode is used to set resolution, compression ratio, sharpness, recording colors, the date, whether to sound a beep, etc. for recorded images. Incidentally, the resolution, compression ratio, etc. of recorded images can be set on menu screens in shooting modes. When Manual Shooting mode is selected, settings of exposure, flash light quantity, focus, etc. can be made manually.

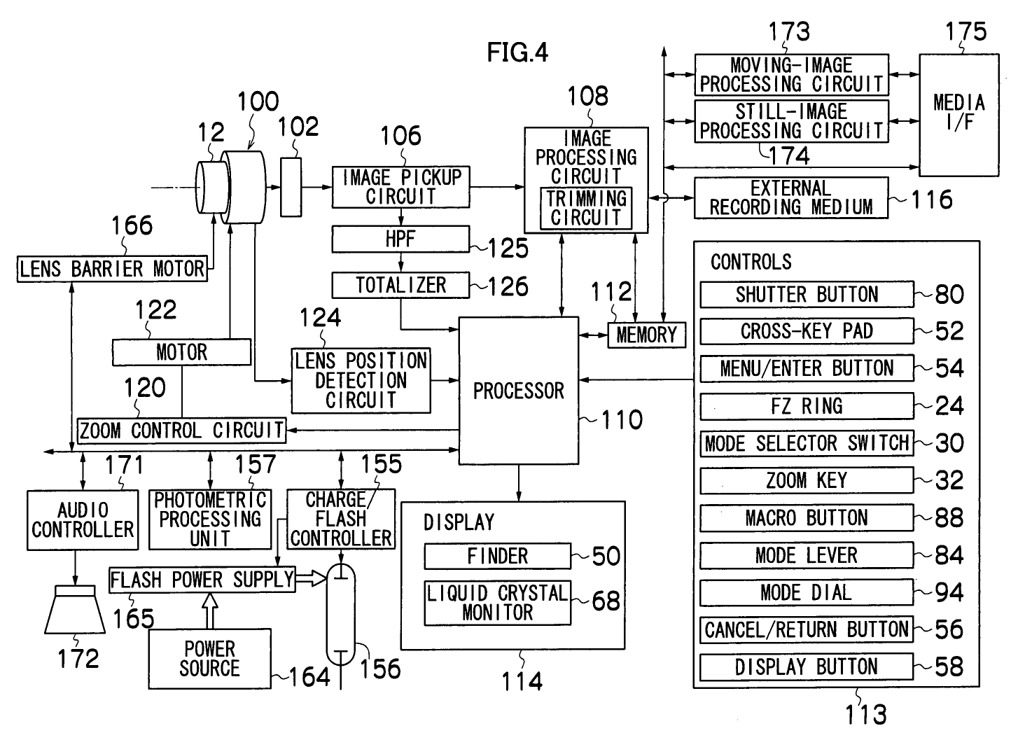

FIG. 4 is a block diagram showing internal configuration of the camera 10. A solid-state image sensor 102 such as a CCD is installed behind an optical unit 100 including the zoom lens 12, so that light passing through the zoom lens 12 enters the solid-state image sensor 102. Photosensors are arranged two-dimensionally on a light-receiving surface of the solid-state image sensor 102, and a subject image formed on the light-receiving surface is converted by the photosensors into signal charges in amounts proportionate to the amounts of the incident light. The signal charges thus accumulated are read out in sequence as voltage signals (image signals) proportionate to the signal charges based on a pulse signal given by a driver circuit (not shown) and are applied to an image pickup circuit 106.

The image pickup circuit 106 includes a gain converter circuit and A/D converter. Image data converted into digital signal by the image pickup circuit 106 is sent to an image processing circuit 108 and high pass filter (HPF) 125. The image processing circuit 108 is an image processing device which includes luminance signal and color-difference signal generator circuit, gamma correction circuit, sharpness correction circuit, contrast correction circuit, white balance correction circuit, contour processing unit which performs image processing including contour correction on images, noise reducer which reduces image noise, trimming circuit, etc. It processes image signals based on commands from a processor 110 consisting of a RISC (Reduced Instruction Set Computer) and the like.

The image data inputted in the image processing circuit 108 are converted into a luminance signal (Y signal) and color-difference signals (Cr and Cb signals), subjected to predetermined processes such as gamma correction, and then stored in a memory 112. On instructions from the processor 110, the image data stored in the memory 112 are read out, converted into a predetermined signal format such as NTSC, and then outputted to a display 114. The display 114 corresponds to the finder 50 incorporated in the camera 10 and an external display unit connected to the liquid crystal monitor 68. Incidentally, the processor 110 includes an OSD signal generator circuit, which generates signals needed to display the shutter speed, the f-stop number, the number of remaining shots, the shooting date/time, characters for warning messages, symbols such as icons, etc. The signals outputted from the OSD signal generator circuit are supplied to the display 114, being mixed in image signals as required. This makes it possible to display a composite image consisting of a see-through image or reproduced image superimposed with characters or icons.

The image data in the memory 112 is rewritten periodically by the image signal outputted from the solid-state image sensor 102 and a video signal generated from the resulting image data is supplied to the display 114. Consequently, the images picked up by the solid-state image sensor 102 are displayed on the display 114 in real time.

When the shutter button 80 is pressed with Shooting mode selected by the mode lever 84 and Still-Image Shooting mode selected by the mode dial 94, a start-shooting command signal is issued. Specifically, focus is achieved by controlling a focus drive (not shown) and exposure is controlled by controlling a charge accumulation time (so-called electronic shutter) of the solid-state image sensor 102.

Upon depression of the shutter button 80, a still-image processing circuit 174 reads image data out of the memory 112, performs predetermined processes on them, compresses them as required, converts them into a still-image file in a predetermined format (e.g., Exif file), and records them on an external recording medium 116 via a media interface 175.

The external recording medium 116 is used to hold the image data obtained by shooting. For example, a memory card called SmartMedia is used as the external recording medium 116. However, the recording media available for use here is not limited to this, and include PC cards, CompactFlash (registered trademark), magnetic disks, optical disks, memory sticks. They may be electronic, magnetic, or optical readable/writable media or a combination thereof. Besides, the camera may be configured to mount multiple media regardless of whether they are of the same type or of different types. Also, image files may be stored not only in a removable medium which can be mounted on and removed from the camera, but also a recording medium (internal memory) incorporated in the camera.

When the mode dial 94 is set to Moving-Image Recording mode, at the press of the shutter button 80, a moving-image processing circuit 173 reads the image data out of the memory 112, converts them into moving-image data, and records them in the external recording medium 116. When the shutter button 80 is pressed again, the recording of the moving-image data stops. It is alternatively possible to continue recording while the shutter button 80 is held down and stop recording when the button is released. The moving-image data are stored in the external recording medium 116 in a predetermined format such as Motion JPEG format.

When the mode lever 84 is set to Playback mode, an image file is read out of the external recording medium 116, decompressed by the image processing circuit 108, and outputted to the display 114.

On the other hand, the image data are converted into a digital signal by the A/D converter of the image pickup circuit 106 and a G-pixel component is extracted from the digital signal by the HPF 125. The extracted G-pixel component is totaled by a totalizer 126 and sent to the processor 110. The processor 110 calculates an average of four areas around the center out of a screenful of image data received from the totalizer 126 and split into 64 areas and uses the average as an estimate of autofocus (AF). An AF estimate is calculated at predetermined intervals and stored in the memory 112 after each calculation by updating the previous AF estimate.

When the photographer switches to C-AF or S-AF mode by operating the mode selector switch 30 and turns the FZ ring 24 in the Tele or Wide direction, the processor 110 drives a motor 122 in response by controlling a zoom control circuit 120. The motor 122 is a DC motor, which can be driven in the Tele or Wide direction by changing the polarity of voltage applied to it. Power of the motor 122 is transmitted to the lens barrel 15 via gears and other power transmission mechanisms (not shown), the lens barrel 15 collapses into or extends from the camera 10, moving the zoom lens 12 in the Tele or Wide direction and thereby changing the focal length.

Incidentally, the cross-key pad 52 may be made to function as zooming keys. For example, as the cross-key pad 52 is viewed with the camera 10 held horizontally, the Up key may be used as a zoom-up key (T key), the Down key may be used as a zoom-down key (W key), and the cross-key pad 52 may be used for optical zoom adjustment instead of the FZ ring 24.

To detect the zoom position of the zoom lens 12, the camera 10 is equipped with a lens position detection circuit 124. Results of detection are sent to the processor 110, which controls the zoom position based on a detection signal from the lens position detection circuit 124.

The lens position detection circuit 124 may be a circuit which generates pulses as the motor 122 rotates or may be a position detecting encoder plate installed around the lens barrel 15 and is not limited to any specific form in carrying out the present invention.

The processor 110 is a controller which generally controls various circuits in the camera 10. It controls the operation of appropriates circuits based on signals received from controls 113 including the shutter button 80, cross-key pad 52, menu/enter button 54, FZ ring 24, mode selector switch 30, zoom key 32, macro button 88, mode lever 84, and mode dial 94. Also, it performs display control in the display 114, flash control, autofocus (AF) control, calculation of trimming ranges, automatic exposure (AE) control, etc.

Also, the processor 110 is connected with a charge/flash controller 155 which controls charging and firing of a flash tube 156 consisting of a Xenon tube. In still-image shooting, if low illuminance is detected by a photometric processing unit 157, a flash command is given via the flash button 86, or Forced Flash mode is set; the processor 110 makes the flash tube 156 fire with a predetermined timing for a short period (e.g., equal to or longer than 1 second).

Each time the camera 10 is turned on, power is supplied from a power source 164 to a flash power supply 165 equipped with a capacitor and the like, changing the flash power supply 165 and thereby preparing it for firing the flash tube 156 during shooting. Under the control of the charge/flash controller 155, power is supplied to the flash tube 156 from the flash power supply 165 to fire the flash tube 156. Alternatively, external power may be supplied to the flash power supply 165 from an AD adapter (not shown) connected to the power source 164.

The image data from the image processing circuit 108 are also sent to the photometric processing unit 157. The photometric processing unit 157 calculates photometric values (exposure value) of subject luminance based on each item of the inputted image data and the charge accumulation time of the solid-state image sensor 102, i.e., the shutter time of the electronic shutter. This adjusts driving of the solid-state image sensor 102. Incidentally, the f-stop number may be varied together with the shutter time (measured in seconds or fractions of seconds) of the electronic shutter. When varying the f-stop number, photometric values of subject luminance is calculated by taking the f-stop number into consideration. In this way, the photometric processing unit 157 detects the brightness of the subject (subject luminance) by TTL (Through The Lens) metering method using the solid-state image sensor 102 as a light-receiving sensor.

When Playback mode is selected with the mode lever 84, compressed data of the last image file (the most recently recorded file) are read out of the external recording medium 116. If the last recorded file is a still-image file, the compressed image data read out are decompressed into a non-compressed YC signal via the image processing circuit 108 and stored in the memory 112. The YC signal in the memory 112 is supplied to the processor 110, which then creates a composite color video signal and displays it on the display 114. Consequently, the display 114 presents a frame image of the last frame stored in the external recording medium 116.

Subsequently, if forward frame advance is specified with the cross-key pad 52 or the like, frames are advanced forward one by one and if a reverse frame advance switch is activated, frames are played back one by one in reverse. Then, the image files of the frames are read out of the external recording medium 116 and played back on the display 114 in the same manner as described above. Incidentally, if forward frame advance is activated when the frame image of the last frame is displayed, the image file of the first frame is read out of the external recording medium 116 and the frame image of the first frame is played back on the display 114.

An audio controller 171 converts monophonic audio data recorded in moving-image files in the external recording medium 116 into an analog audio signal and outputs the signal to a loudspeaker 172. The loudspeaker 172 outputs sound based on this signal. The audio controller 171 may remove high-frequency components which constitutes noise from the analog audio signal or amplify the analog audio signal. Of course, the audio controller 171 may support audio modes (such as two-channel stereo or Dolby digital 5.1-channel audio) other than monophonic sound.

Needless to say, embodiments of the image pickup apparatus according to the present invention is not limited to digital cameras and may be camera-equipped cell phones.

[Flow of Processes]

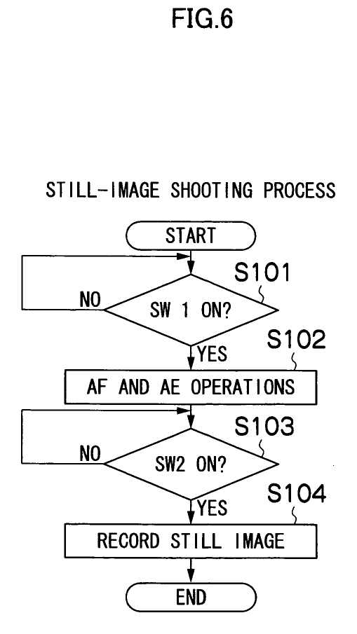

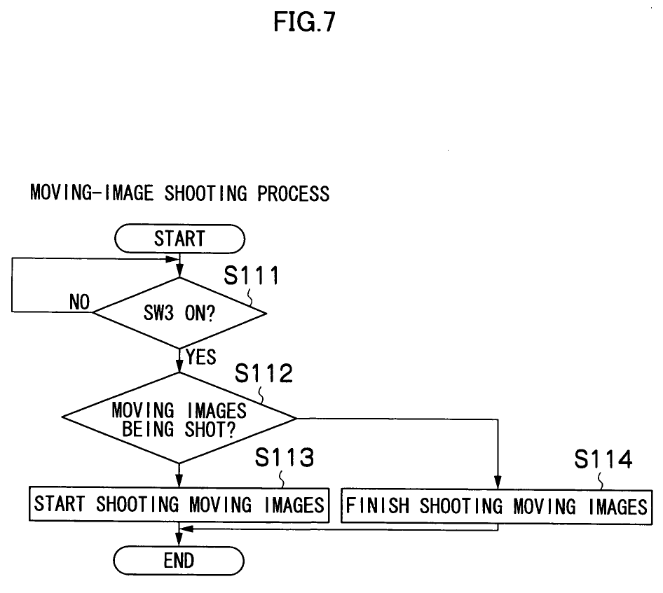

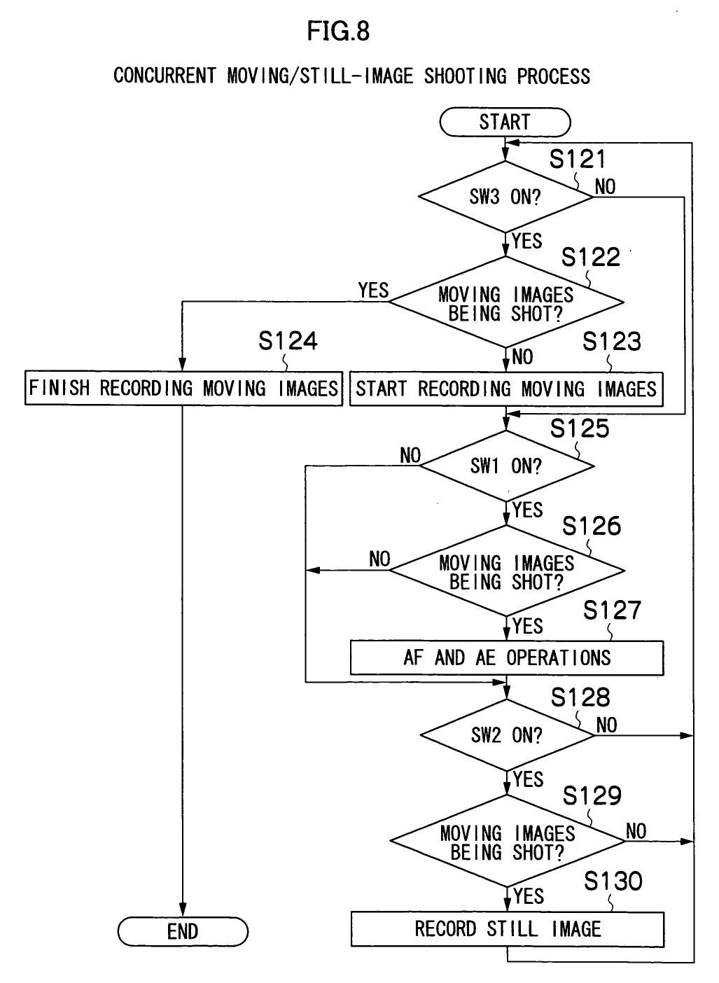

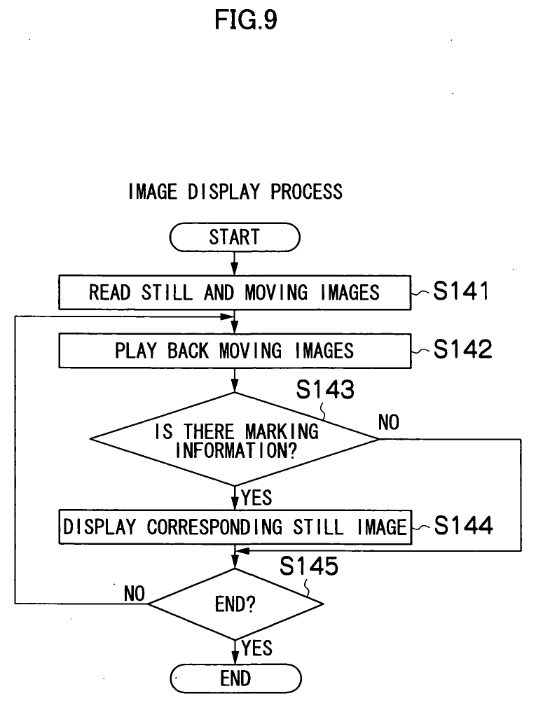

Flows of still-image shooting, moving-image shooting, concurrent moving/still-image shooting, and moving/still-image playback carried out according to the mode setting of the mode lever 84 or mode dial 94 will be described below with reference to flowcharts shown in FIGS. 6 to 8. When the mode dial 94 is set to Still-Image Shooting mode, the flow goes to a still-image shooting process in FIG. 6; when the mode dial 94 is set to Moving-Image Shooting mode, the flow goes to a moving-image shooting process in FIG. 7; and when the mode dial 94 is set to Concurrent Moving/Still-Image Shooting mode, the flow goes to a concurrent moving/still-image shooting process in FIG. 8. On the other hand, when the mode lever 84 is set to Playback mode, the flow goes to an image display process in FIG. 9.

(Still-Image Shooting Process)

First, the flow of the still-image shooting process will be described with reference to FIG. 6. When the photographer presses the shutter button 80 from an initial position S0 (where none of the switches SW1 to SW3 is ON and the shutter button 80 waits to be pressed) to the first depressed position S1 and holds it there, turning on the switch SW1 (Step S101: Y), the flow goes to Step S102, where preparatory operations for still-image shooting including automatic focusing (AF) and automatic exposure (AE) control are activated. When the photographer presses the shutter button 80 further from “half press” to the second depressed position S2 (full press) and holds it there, turning on the switch SW2 (Step S103: Y), the flow goes Step S104, where a still image is recorded. Incidentally, even if the photographer presses the shutter button 80 further from “full press” to the third depressed position S3 and holds it there, turning on the switch SW3, this operation is invalidated and the camera 10 does not perform preparatory operations for still-image shooting or operations related to still-image recording such as a recording start operation. However, the camera 10 may be designed to start recording a still image as in the case of full press when the shutter button 80 is pressed from half press to the third depressed position S3. Incidentally, when the photographer stops pressing the shutter button 80, it returns to the initial position S0 from any of the depressed positions S1 to S3 by the restoring force of a spring or the like.

(Moving-Image Shooting Process)

Next, the flow of the moving-image shooting process will be described with reference to FIG. 7. When the photographer presses the shutter button 80 from the initial position S0 to the third depressed position S3 in one stroke and holds it there, turning on the switch SW3 (Step S111: Y), the flow goes to Step S112, where it is determined whether moving-image shooting has already started. If it is determined that moving-image shooting has not started yet, the flow goes to Step S113 to start recording moving images. On the other hand, if it is determined that moving-image shooting has already started, the flow goes to Step S114 to stop recording moving images.

Incidentally, even if the photographer presses the shutter button 80 from the initial position S0 to S1 or S2 and holds it, the camera 10 does not perform operations related to moving-image shooting such as the operation of starting or finishing moving-image shooting.

It is not strictly necessary to use the switch SW3 in controlling the start and end of moving-image shooting. Specifically, it may be determined in Step S111 whether the switch SW2 is ON instead of determining whether the switch SW3 is ON and the process may go to Step S112 when the switch SW2 is ON. Alternatively, it may be determined in Step S111 whether the switch SW1 is ON and the process may go to Step S112 when the switch SW1 is ON.

(Concurrent Moving/Still-Image Shooting Process)

Next, the flow of the concurrent moving/still-image shooting process will be described with reference to FIG. 8. When the photographer presses the shutter button 80 from the initial position S0 to the third depressed position S3 in one stroke and holds it there, turning on the switch SW3 (Step S121: Y), the flow goes to Step S122, where it is determined whether moving-image shooting has already started. If it is determined that moving-image shooting has not started yet, the flow goes to Step S123, where the moving-image processing circuit 173 starts recording moving images. On the other hand, if it is determined that moving-image shooting has already started, the flow goes to Step S124 to stop recording moving images.

In Step S125, it is determined whether the shutter button 80 is pressed to the first depressed position S1 and held there, turning on the switch SW1. If the switch SW1 is ON, the flow goes to Step S126. If the switch SW1 is not ON, the flow goes to Step S128.

In Step S126, it is determined whether moving-image shooting has already started. If it is determined that moving-image shooting has not started yet, the flow goes to Step S128. On the other hand, if it is determined that moving-image shooting has already started, the flow goes to Step S127 to perform such preparatory operations for shooting as in Step S102 above.

In Step S128, it is determined whether the shutter button 80 is pressed to the second depressed position S2 and held there, turning on the switch SW2. If the switch SW2 is ON, the flow goes to Step S129. If the switch SW2 is not ON, the flow returns to Step S121. In Step S129, it is determined whether moving-image shooting has already started. If it is determined that moving-image shooting has not started yet, the flow returns to Step S121. On the other hand, if it is determined that moving-image shooting has already started, the flow goes to Step S130.

In Step S130, a still-image shooting operation is started during the shooting of moving images. Upon activation of the switch SW2, the still-image processing circuit 174 creates a still image from image data stored in the memory 112, converts it into a predetermined file format, and records it in the external recording medium 116. Even while the still-image processing circuit 174 is recording still images, the moving-image processing circuit 173 reads image data out of the memory 112, converts them into moving-image data and records them in the external recording medium 116.

On the other hand, the moving-image processing circuit 173 records marking information which identifies the still image by associating it with the reproduced frame of the moving-image file recorded just when the still image is recorded. It is assumed, for example, that moving images are recorded in a MPEG2 file, which has a structure consisting of a sequence of data collections called GOP (Group OF Pictures). A GOP consists of three types of video data: “I picture” which is close to a still image, “P picture” whose behavior is predicted with reference to the I picture, and “B picture” whose behavior is predicted with reference to the I and P pictures before and after it. Moving images are composed by arranging these pictures orderly. When the photographer presses the shutter button 80 to the second depressed position S2, thereby giving a command to record a still image, marking information is attached to the I picture created from the image data read out of the memory 112. The marking information identifies the still image corresponding to a reproduced frame of moving images and contains identification information about the still image such as an Exif file name of the still image. Audio data such as a shutter click may be included in the marking information.

When recording of the still image in S30 is finished, the flow returns to S21. Incidentally, if the photographer stops pressing the shutter button 80 located at the first depressed position S1 or second depressed position S2 and thereby allows them to return to the initial position S0, the photographer can repeat preparatory operations for shooting and recording of still images any number of times by turning on the switch SW1 or SW2 while moving images are being recorded.

(Playback Process)

Next, the flow of the image display process carried out to display both moving images and still images recorded in the external recording medium 116 as described above will be described with reference to FIG. 9.

In S41, the still-image files such as Exif files and a moving-image file such as an MPEG2 file read out of the memory 112 are stored in the external recording medium 116.

In S42, predetermined operations of controls 113 cause moving images to start being played back on the display 114. Moving images can be displayed in any of the finder 50 and liquid crystal monitor 68. However, for convenience of explanation, it is assumed here that the moving images are displayed on the liquid crystal monitor 68.

In S43, it is determined whether there is marking information associated with a reproduced frame of the moving images currently being played back. If there is marking information, the flow goes to S44. If there is no marking information, the flow goes to S45.

In S44, the still image identified by the marking information which is associated with a reproduced frame of the moving images currently being played back is read out of the memory 112 and displayed on the liquid crystal monitor 68. If the marking information associated with the reproduced frame of the moving images currently being played back contains audio data such as a shutter click, the audio controller 171 converts the audio data into an analog audio signal and outputs it to the loudspeaker 172.

In S45, it is determined whether the moving images have been played back to the last frame. If the last frame has not been played back yet, the flow goes to S42 to continue playing back the moving images. If the last frame has been played back, the playback of the moving images is finished.

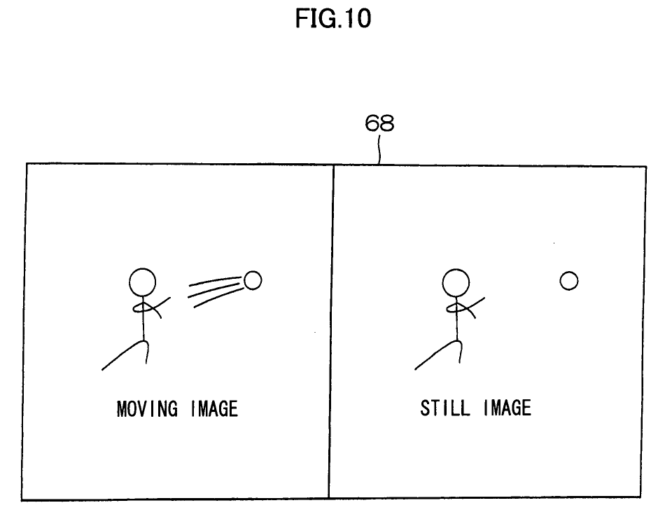

FIG. 10 shows how the still image identified by the marking information which is associated with a reproduced frame of the moving images currently being played back is displayed on the liquid crystal monitor 68 together with the moving images in S44. As shown in the figure, the liquid crystal monitor 68 simultaneously displays moving images and the still image associated with the reproduced frame of the moving images. This makes it possible to view both moving images and still images shot concurrently during the shooting of the moving images. If the marking information contains audio data, it is played back through the loudspeaker 172 when the still image is displayed. Consequently, the shooting time of the still image can be announced by sound during playback of moving images.

If a thumbnail image created by reducing the still image at a predetermined reduction ratio is recorded in the Exif file of the still image, the thumbnail image may be displayed on the liquid crystal monitor 68 instead of the still image itself. This will reduce the display space of the still image. Alternatively, a still image may be displayed alone on the liquid crystal monitor 68 by interrupting the playback of moving images for a predetermined period of time (e.g., 3 seconds). Also, the user may be allowed to specify, using a control 113, whether to play back moving images alone or together with the still images identified by marking information. In that case, in the mode in which still images are displayed during the playback of moving images, the still images identified by marking information can be displayed as described above. On the other hand, in the mode in which only moving images are played back, any marking information can be ignored without displaying the still image, and any audio data contained in marking information can be ignored without playing back the sound.

### Second Embodiment

According to the first embodiment, the shutter button 80 has a three-step configuration consisting of the first depressed position S1, second depressed position S2, and third depressed position S3. However, even if the shutter button 80 has a two-step configuration, it is possible to give commands to start or stop recording moving images or start recording still images.

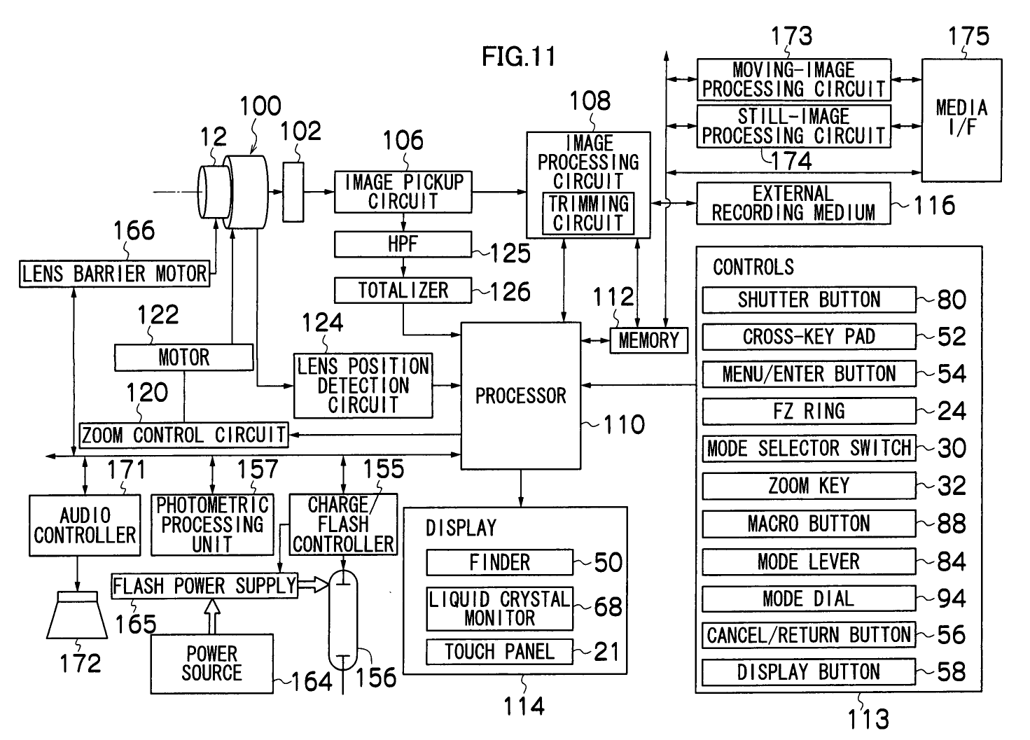

FIG. 11 is a block diagram of a digital camera according to a second embodiment. In addition to the configuration of the first embodiment, this digital camera has a touch panel 21. The touch panel 21 is made of a transparent member and laid over the liquid crystal monitor 68. The touch panel 21 has predetermined resistance values arranged along rows and columns of a matrix. When an object such as a user's finger touches the panel, the resistance values change and the tough position of the object can be detected by sensing changes in current values.

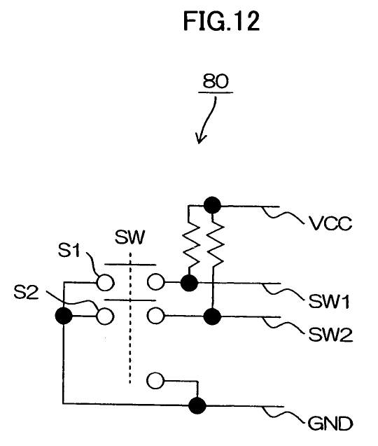

As shown in FIG. 12, the shutter button 80 can be pressed in two steps to the first depressed position S1 and second depressed position S2, as is conventionally the case. When the shutter button 80 is pressed lightly to the first depressed position S1 (half pressed) and its stroke is stopped there, a switch SW1 is activated. When the shutter button 80 is pressed from the first depressed position S1 to the second depressed position S2 (fully pressed) and its stroke is stopped there, a switch SW2 is activated. The rest of the configuration of the digital camera is the same as that of the first embodiment, and thus description thereof will be omitted.

When the digital camera has the above configuration, there is no operation which corresponds to the activation of the switch SW3 according to the first embodiment. Therefore, part of the moving-image shooting process and concurrent moving/still-image shooting process is changed as follows.

First, regarding the moving-image shooting process (see FIG. 7), as described in the first embodiment, it may be determined in Step S111 whether the switch SW1 is ON instead of determining whether the switch SW3 is ON and the process may go to Step S112 when the switch SW1 is ON. Alternatively, it may be determined whether the switch SW2 is ON and the process may go to Step S112 when the switch SW2 is ON.

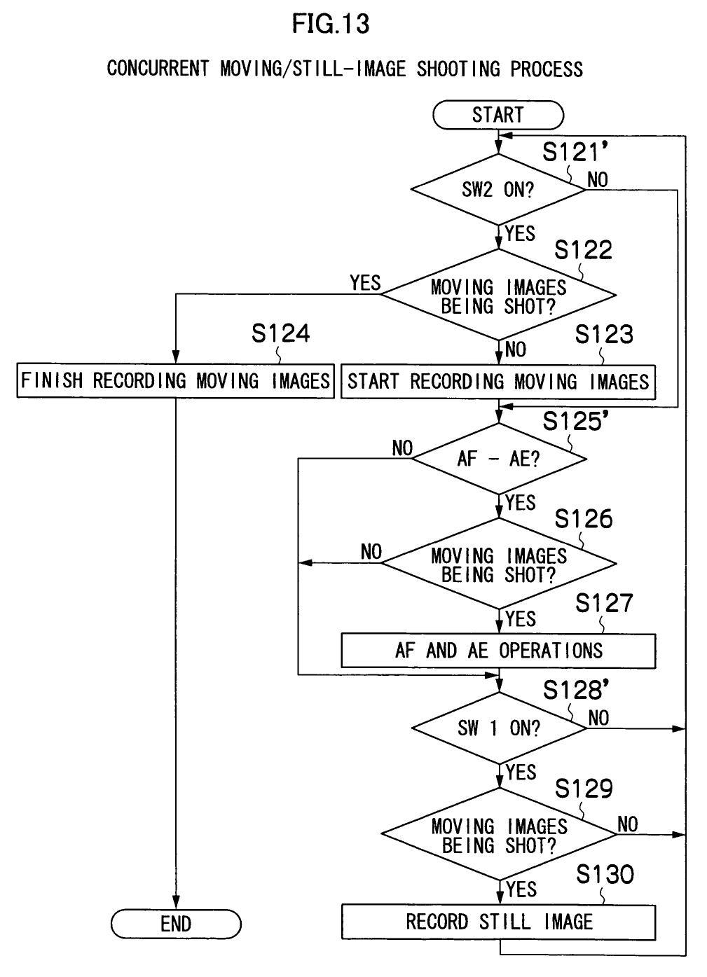

As to the concurrent moving/still-image shooting process, referring to FIG. 13, it may be determined in Step S121′ whether the switch SW2 is ON and the process may go to Step S122 when the switch SW2 is ON, or go to Step S125′ when the switch SW2 is not ON.

In Step S125′, it is determined whether an AF/AE start command is entered via the touch panel 21. As a concrete example of an AF/AE start command, an area of a see-through image to be focused on can be specified via the touch panel 21, but this is not restrictive.

In Step S128′, it is determined whether the switch SW1 is ON and the flow goes to Step S129 when the switch SW1 is ON, or goes to Step S121 when the switch SW1 is not ON.

The processes in steps other than S121′, S125′, and S128′ are the same as those in the first embodiment, and thus description thereof will be omitted.

In this way, if an AF/AE start command is allowed to be entered via the touch panel 21, even a digital camera equipped with a shutter button 80 of a conventional two-step configuration can perform the concurrent moving/still-image shooting process according to the present invention.

Incidentally, it is not strictly necessary to use the touch panel 21 to accept an AF/AE start command. An input device consisting of a dedicated operation switch or user interface may be installed on the digital camera to accept the AF/AE start command.

What is claimed is:

1. An image pickup apparatus comprising:
an image pickup unit which outputs image data based on light coming from a subject via a taking lens;
a moving-image recording unit which records moving images on a recording medium based on the image data outputted from the image pickup unit;
a still-image recording unit which records still images on a recording medium based on the image data outputted from the image pickup unit;
an operation switch which accepts a push operation to a first or second depressed position; and
a recording controller which controls the still-image recording unit so as to record the still images on the recording medium when the operation switch is pressed to the first depressed position, and controls the moving-image recording unit so as to start or stop recording the moving images when the operation switch is pressed to the second depressed position.

2. The image pickup apparatus according to claim 1, wherein:
the operation switch accepts a push operation to any of a first to third depressed position; and
the recording controller controls the still-image recording unit so as to record the still images on the recording medium when the operation switch is pressed to the first or second depressed position, and controls the moving-image recording unit so as to start or stop recording the moving images when the operation switch is pressed to the third depressed position.

3. The image pickup apparatus according to claim 2, wherein:
the recording controller controls the image pickup unit so as to prepare to carry out imaging of the subject when the operation switch is pressed to the first depressed position, and controls the still-image recording unit so as to record the still images on the recording medium when the operation switch is pressed to the second depressed position.

4. The image pickup apparatus according to claim 3, wherein:
if the operation switch is pressed to the second depressed position during recording of the moving images, the recording controller controls the still-image recording unit so as to record the still images based on the same image data as the image data in moving-image frames recorded just when the operation switch is pressed to the second depressed position.

5. The image pickup apparatus according to claim 4, wherein:
the moving-image recording unit records marking information which identifies the still images by associating the marking information with moving-image frames recorded just when the operation switch is pressed to the second depressed position.

6. The image pickup apparatus according to claim 5, wherein:
the marking information includes audio data.

7. An image playback method comprising the steps of:
recording moving images;
recording still images during recording of moving images;
recording marking information which identifies the still images by associating the marking information with moving-image frames recorded just when the still images are recorded;
playing back the recorded moving images on a display unit;
identifying the still images based on the marking information corresponding to moving-image frames being played back; and
displaying the identified still images on the display unit together with the moving images being played back.

8. An image playback method according to claim 7, wherein:
the marking information includes audio data; and
the image playback method further comprises the step of playing back sound based on the audio data of the marking information corresponding to moving-image frames being played back.
